(19) United States
(12) Patent Application Publication
(10) Pub. No.: US 2010/0074557 A1
(43) Pub. Date: Mar. 25, 2010

(54) Image Processing Device And Electronic Appliance

(75) Inventors: Tomoki OKU, Osaka (JP); Masahiro YOKOHATA, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/567,190

(22) Filed: Sep. 25, 2009

(30) Foreign Application Priority Data
Sep. 25, 2008 (JP) 2008245665
Jul. 24, 2009 (JP) 2009172838

(51) Int. Cl. G06K 9/36

(52) U.S. Cl. 382/291; 382/298

(57) ABSTRACT

An image processing device has: a main subject detector that detects the position of a main subject in an input image; a clipping region setter that determines a clipping region including the position of the main subject detected by the main subject detector; and a clipper that generates a clipped image by cutting out the clipping region from the input image. The clipping region setter determines the clipping region such that the position of the main subject detected by the main subject detector coincides with a predetermined position in the clipping region.

This application is based on Japanese Patent Application No. 2008-245665 filed on Sep. 25, 2008 and Japanese Patent Application No. 2009-172838 filed on Jul. 24, 2009, the contents of both which are hereby incorporated by reference.

### BACKGROUND OF THE INVENTION

1. Field of the Invention

The present invention relates to an image processing device that cuts out part of an input image to yield a desired clipped image, and to an electronic appliance provided with such an image processing device.

2. Description of Related Art

Today, image shooting devices such as digital still cameras and digital video cameras that perform shooting by use of an image sensor such as a CCD (charge-coupled device) or CMOS (complimentary metal oxide semiconductor) sensor, and display devices such as liquid crystal displays that display images, are widespread. Some of these image shooting devices and display devices have a capability of cutting out a predetermined region from a processing target image (hereinafter referred to as an input image) and recording or displaying the image thus cut out (hereinafter referred to as a clipped image).

Such clipping processing helps simplify shooting. Specifically, the user has simply to shoot an input image with a wide angle of view, and the input image thus obtained is subjected to clipping processing to allow the user to cut out a region including the particular subject the user wants to shoot (hereinafter referred to as the main subject). The processing thus eliminates the need for the user to concentrate on following the main subject to obtain an image so composed as to include it. That is, the user has simply to point the image shooting device to the main subject in rather a rough way.

Inconveniently, however, clipping an input image, depending on how it is done, does not always yield a satisfactory clipped image. For example, a large part of the main subject may lie outside the clipping region, resulting in the clipping region showing only a limited part of the main subject. For another example, even when the main subject is included in the clipping region, almost no surroundings around it may appear there, leaving little hint of what is around.

Allowing the user to specify the clipping region each time he wants to (e.g., at predetermined time intervals) during shooting or playback may make selection of the desired clipping region possible. Specifying the clipping region so often during shooting or playback, however, is difficult and troublesome.

### SUMMARY OF THE INVENTION

According to one aspect of the present invention, an image processing device is provided with: a main subject detector that detects the position of a main subject in an input image; a clipping region setter that determines a clipping region including the position of the main subject detected by the main subject detector; and a clipper that generates a clipped image by cutting out the clipping region from the input image. Here, the clipping region setter determines the clipping region such that the position of the main subject detected by the main subject detector coincides with a predetermined position in the clipping region.

According to another aspect of the present invention, an electronic appliance is provided with the image processing device described above. Here, the clipped image outputted from the image processing device is recorded or played back.

### BRIEF DESCRIPTION OF THE DRAWINGS

FIG. 1 is a block diagram showing the configuration of an image shooting device as one embodiment of the invention;

FIG. 2 is a block diagram showing the basic configuration of the clipping processing portion provided in an image shooting device embodying the invention;

FIG. 3 is a flow chart showing the basing operation of the clipping processing portion provided in an image shooting device embodying the invention;

FIG. 4 is a schematic diagram illustrating an example of the detection method adopted by the main subject detection portion in Practical Example 1 of the invention;

FIG. 5 is a schematic diagram illustrating an example of the detection method adopted by the main subject detection portion in Practical Example 2 of the invention;

FIGS. 6A and 6B are schematic diagrams illustrating an example of the detection method adopted by the main subject detection portion in Practical Example 3 of the invention

FIG. 7 is a schematic diagram illustrating an example of the detection method adopted by the main subject detection portion in Practical Example 5 of the invention;

FIGS. 8A and 8B are schematic diagrams illustrating an example of the clipping method adopted by the clipping region setting portion in Practical Example 1;

FIGS. 9A to 9C are schematic diagrams illustrating an example of the clipping method adopted by the clipping region setting portion in Practical Example 2;

FIGS. 10A and 10B are schematic diagrams illustrating an example of the clipping method adopted by the clipping region setting portion in Practical Example 3;

FIG. 11 is a schematic diagram illustrating another example of the clipping method adopted by the clipping region setting portion in Practical Example 3;

FIG. 12 is a block diagram showing an example of the configuration of a clipping processing portion that can generate a clipped image even when the main subject is composed of a plurality of component subjects;

FIG. 13 is a schematic diagram showing an example of a clipping region determined based on a plurality of component subjects;

FIG. 14 is a schematic diagram showing another example of a clipping region determined based on a plurality of component subjects;

FIG. 15 is a schematic diagram showing another example of a clipping region determined based on a plurality of component subjects; and

FIG. 16 is a block diagram showing the configuration of an image shooting device as another embodiment of the invention.

### DETAILED DESCRIPTION OF PREFERRED EMBODIMENTS

Embodiments of the present invention will be described below with reference to the accompanying drawings. First, an image shooting device as an example of an electronic appliance according to the invention will be described. The image shooting device described below is one, such as a digital camera, that is capable of recording sounds, moving images (movies), and still images (pictures).

### Image Sensing Device

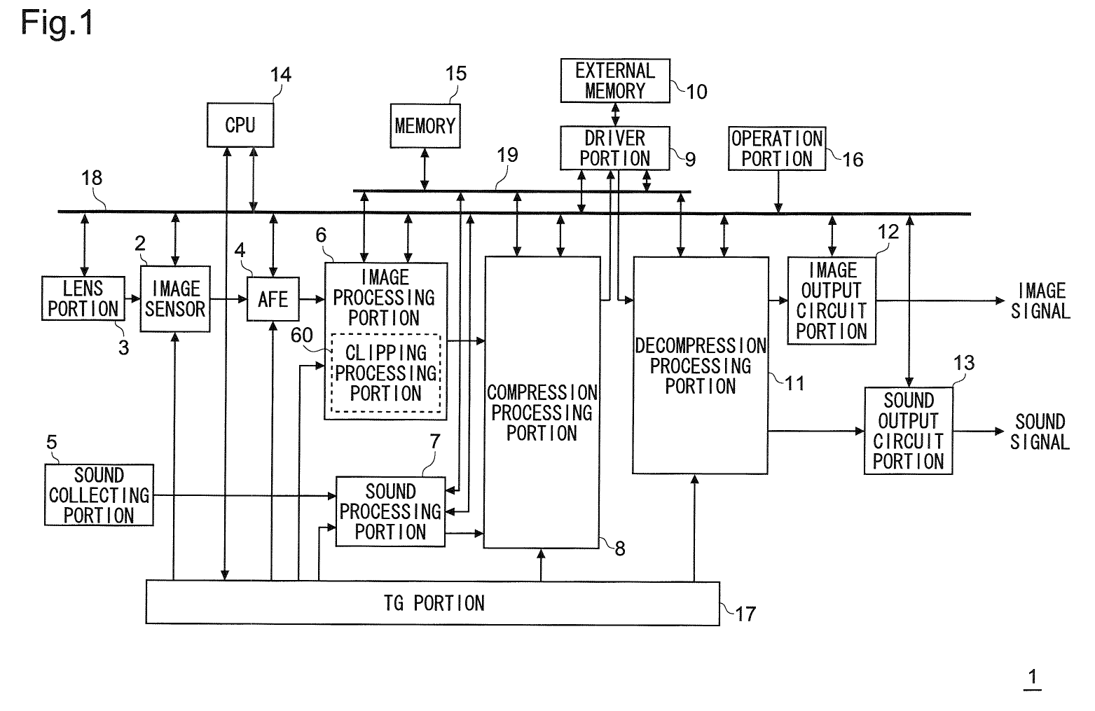

First, the configuration of the image shooting device will be described with reference to FIG. 1. FIG. 1 is a block diagram showing the configuration of the image shooting device as one embodiment of the invention.

As shown in FIG. 1, the image shooting device 1 is provided with: an image sensor 2 composed of a solid-sate image sensing device, such as a CCD or CMOS sensor, that converts the optical image formed on it into an electrical signal; and a lens portion 3 that forms an optical mage of a subject on the image sensor 2 while adjusting the amount of incident light etc. The lens portion 3 and the image sensor 2 constitute an image shooting portion, which generates an image signal. The lens portion 3 is provided with: various lenses (unillustrated) such as a zoom lens and a focus lens; an aperture stop (unillustrated) for adjusting the amount of light incident on the image sensor 2; etc.

The image shooting device 1 is further provided with: an AFE (analog front end) 4 that converts the image signal—an analog signal—outputted from the image sensor 2 into a digital signal and that adjusts the gain; a sound collecting portion 5 that collects sounds and converts them into an electrical signal; an image processing portion 6 that converts the image signal—R (red), G (green), and B (blue) digital signals—outputted from the AFE 4 into a signal using Y (luminance) and U and V (color difference) signals and that subjects the image signal to various kinds of image processing; a sound processing portion 7 that converts the sound signal—an analog signal—outputted from the sound collecting portion 5 into a digital signal; a compression processing portion 8 that subjects the image signal outputted from the image processing portion 6 to compression/encoding processing for still images such as by a JPEG (Joint Photographic Experts Group) compression method and that subjects the image signal outputted from the image processing portion 6 and the sound signal from the sound processing portion 7 to compression/encoding processing for moving images such as by an MPEG (Moving Picture Experts Group) compression method; an external memory 10 to which the compressed/encoded signal compressed/encoded by the compression processing portion 8 is recorded; a driver portion 9 that records and reads the compressed/encoded signal to and from the external memory 10; and a decompression processing portion 11 that decompresses and decodes the compressed/encoded signal read from the external memory 10. The image processing portion 6 is provided with a clipping processing portion 60 that cuts out part of the image signal fed to it to yield a new image signal.

The image shooting device 1 is further provided with: an image output circuit portion 12 that converts the image signal decoded by the decompression processing portion 11 into a signal of a format displayable on an image display device (unillustrated) such as a display; and a sound output circuit portion 13 that converts the sound signal decoded by the decompression processing portion 11 into a signal reproducible on a sound playback device (unillustrated) such as a speaker.

The image shooting device 1 is further provided with: a CPU (central processing unit) 14 that controls the overall operation within the image shooting device 1; a memory 15 in which programs for various kinds of processing are stored and in which signals are temporarily saved during execution of programs; an operation portion 16 including a button for starting shooting, buttons for choosing various settings, etc. by which the user enters commands; a timing generator (TG) portion 17 that outputs a timing control signal for synchronizing the operation of different parts; a bus 18 across which signals are exchanged between the CPU 14 and different parts; and a bus 19 across which signals are exchanged between the memory 15 and different parts.

The external memory 10 may be of any type so long as image signals and sound signals can be recorded to it. Usable as the external memory 10 are, for example, a semiconductor memory such as an SD (Secure Digital) card, an optical disc such as a DVD, a magnetic disk such as a hard disk, etc. The external memory 10 may be removable from the image shooting device 1.

Next, the basic operation of the image shooting device 1 will be described with reference to FIG. 1. First, the image shooting device 1 acquires an image signal as an electrical signal by subjecting the light it receives through the lens portion 3 to photoelectric conversion by the image sensor 2. Then, in synchronism with the timing control signal fed from the TG portion 17 to it, the image sensor 2 outputs the image signal sequentially at a predetermined frame period (e.g., 1/30 seconds) to the AFE 4. The AFE 4 converts the image signal from an analog to a digital signal, and feeds the result to the image processing portion 6. The image processing portion 6 converts the image signal into a signal using YUV signals and subjects it to various kinds of image processing such as gradation correction and edge enhancement. The memory 15 functions as a frame memory, temporarily holding the image signal while the image processing portion 6 processes it.

Meanwhile, based on the image signal fed to the image processing portion 6, the lens portion 3 adjusts the positions of different lenses to adjust the focus, and adjusts the aperture of the aperture stop to adjust the exposure. Here, the focus and exposure are each adjusted to be optimal either automatically according to a predetermined program, or manually according to commands from the user. The clipping processing portion 60 provided in the image processing portion 6 performs clipping processing; that is, it cuts out part of the image fed to it to generate a new image signal.

In a case where a moving image is recorded, not only the image signal but also a sound signal is recorded. The sound signal outputted from the sound collecting portion 5—the electrical signal into which it converts the sounds it collects—is fed to the sound processing portion 7, which then digitizes it and subjects it to processing such as noise elimination. Then, the image signal outputted from the image processing portion 6 and the sound signal outputted from the sound processing portion 7 are both fed to the compression processing portion 8, which then compresses them by a predetermined compression method. Here, the image signal and the sound signal are temporally associated with each other so that, at the time of playback, they can be kept synchronized. The compressed image and sound signals are then recorded via the driver portion 9 to the external memory 10.

On the other hand, in a case where a still image, or sound alone, is recorded, the image signal or the sound signal is compressed by the compression processing portion 8 by a predetermined compression method, and is then recorded to the external memory 10. The image processing portion 6 may perform different processing between when a moving image is recorded and when a still image is recorded.

The compressed image and sound signals recorded to the external memory 10 are, on a command from the user, read by the decompression processing portion 11. The decompression processing portion 11 decompresses the compressed image and sound signals, and feeds the resulting image signal to the image output circuit portion 12 and the resulting sound signal to the sound output circuit portion 13. Then, the image output circuit portion 12 and the sound output circuit portion 13 convert them into signals reproducible on a display and a speaker and outputs them.

The display and the speaker may be incorporated into the image shooting device 1, or may be provided separate from the image shooting device 1 to be connected to terminals provided in it by cables or the like.

In a case where the image signal is not recorded but is simply displayed on a display or the like for confirmation by the user, that is, in a so-called preview mode, the image signal outputted from the image processing portion 6 may be outputted to the image output circuit portion 12 without being compressed. When the image signal of a moving image is recorded, while it is recorded to the external memory 10 after being compressed by the compression processing portion 8, it may simultaneously be outputted via the image output circuit portion 12 to a display or the like.

It is here assumed that the clipping processing portion 60 provided in the image processing portion 6 can acquire, whenever necessary, various kinds of information (e.g., a sound signal, and encoding information at the time of compression processing) from different parts (e.g., the sound processing portion 7, the compression processing portion 8, etc.) of the image shooting device 1. In FIG. 1, however, illustration is omitted of arrows indicating such information being fed to the clipping processing portion 60.

### Clipping Processing Portion

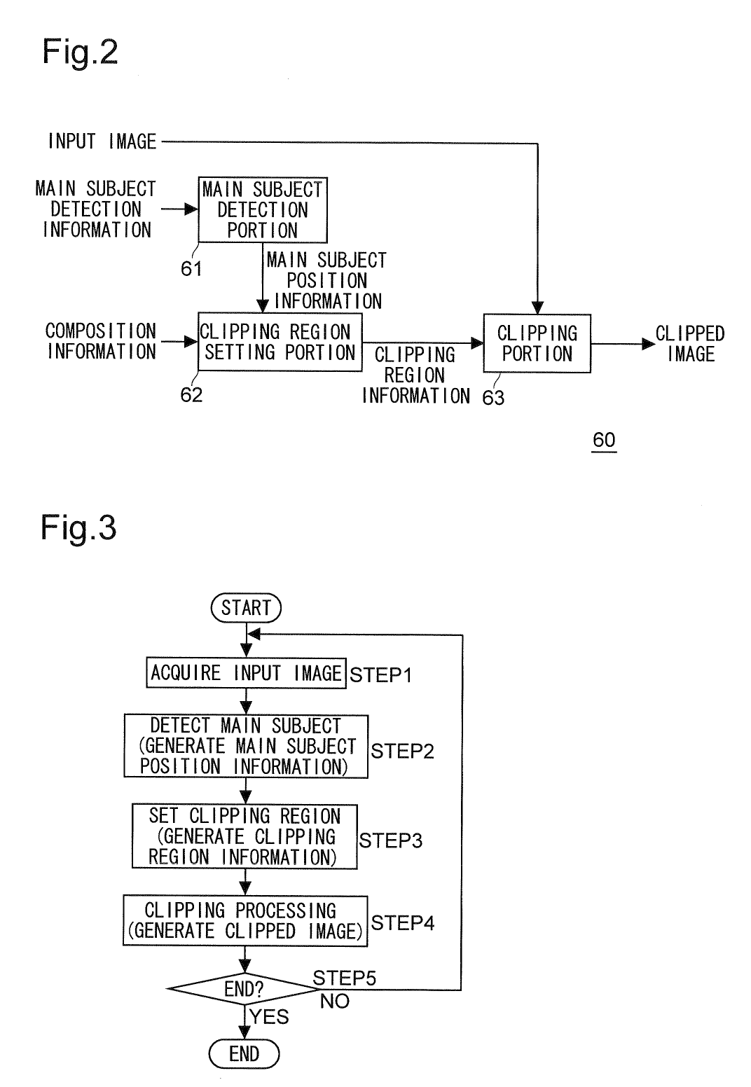

Next, the basic configuration of the clipping processing portion 60 shown in FIG. 1 will be described with reference to the relevant drawing. FIG. 2 is a block diagram showing the basic configuration of the clipping processing portion provided in an image shooting device embodying the invention. In the following description, for the sake of concrete description, the image signal fed to the clipping processing portion 60 to be subjected to clipping processing there is handled as an image, and is referred to as the “input image.” On the other hand, the image signal outputted from the clipping processing portion 60 is referred to as the “clipped image.”

The clipping processing portion 60 is provided with: a main subject detection portion 61 that detects the position of a main subject in the input image based on main subject detection information to output main subject position information; a clipping region setting portion 62 that determines the composition of the clipped image based on the main subject position information to output clipping region information; and a clipping portion 63 that cuts out part of the input image based on the clipping region information to generate the clipped image.

Usable as the main subject detection information are, for example, the input image, the sound signal corresponding to the input image, encoding information at the time of compression processing by the compression processing portion 8, etc. The method by which a main subject is detected by use of those items of main subject detection information will be described in detail later.

The clipping region setting portion 62 also receives composition information. The composition information is information indicating what region—one including the detected position of the main subject—to take as the clipping region. The composition information is entered, for example, by the user at the time of initial setting. The method by which the clipping region setting portion 62 determines the clipping region will be described in detail later.

Now, the basic operation of the clipping processing portion 60 will be described with reference to the relevant drawing. FIG. 3 is a flow chart showing the basic operation of the clipping processing portion provided in an image shooting device embodying the invention. As shown in FIG. 3, the clipping processing portion 60 first acquires the input image—the target of its clipping processing (STEP 1).

The main subject detection portion 61 detects a main subject included in the acquired input image (STEP 2). Here, the main subject detection portion 61 detects the main subject by use of main subject detection information, that is, information corresponding to the input image acquired at STEP 1. The main subject detection portion 61 then outputs main subject position information.

Next, the clipping region setting portion 62 sets a clipping region based on the main subject position information, and outputs clipping region information (STEP 3). The clipping portion 63 then cuts out the region indicated by the clipping region information from the input image to generate a clipped image (STEP 4).

Now, whether or not a command to end the clipping processing has been entered is checked (STEP 5). If no command to end the clipping processing has been entered (STEP 5, “NO”), a return is made to STEP 1, where the input image of the next frame is acquired. Then, the operations in STEPs 2 through 4 are performed to generate a clipped image for the next frame. By contrast, if a command to end the clipping processing has been entered (STEP 5, “YES”), it is ended.

With this configuration, it is possible to cut out, from the input image, an image including the detected main subject and having a desired composition, and thereby to generate a clipped image. In particular, it is possible, without requiring the user to set a clipping region each time he wants to, to set a clipping region according to the position of the main subject. It is thus possible to generate a clipped image including the main subject easily and accurately.

### Main Subject Detection Portion

Next, the detection method adopted by the main subject detection portion 61 will be described in detail by way of a few practical examples, with reference to the relevant drawings.

### Practical Example 1

Main Subject Detection Portion: In Practical Example 1, the main subject is detected based on image information. In particular, as the main subject detection information shown in FIG. 2, the input image is used and, based on this input image, the main subject is detected. More specifically, the input image is subjected to face detection processing to detect a face region, and the position of this face region is taken as the position of the main subject.

An example of a face detection processing method will now be described with reference to the relevant drawing. FIG. 4 is a schematic diagram illustrating an example of the detection method adopted by the main subject detection portion in Practical Example 1. It shows, in particular, an example of a face detection processing method. It should be understood that the method shown in FIG. 4 is merely an example, and any other known face detection processing method may be used instead.

In this practical example, it is assumed that a face is detected by comparing the input image with a weight table. A weight table is obtained from a large number of training samples (sample images of face and non-faces). Such a weight table can be created, for example, by use of a known learning algorithm called AdaBoost (Yoav Freund, Robert E. Schapire, “A decision-theoretic generalization of on-line learning and an application to boosting,” European Conference on Computational Learning Theory, Sep. 20, 1995). AdaBoost is one of adaptive boosting learning algorithms. According to AdaBoost, based on a large number of training samples, a plurality of weak classifiers effective in classification are selected out of a plurality of candidate weak classifiers, and they are then weighted and integrated into a high-accuracy classifier. Here, weak classifiers denote classifiers whose classifying performance is higher than that by sheer chance but not so high as to fulfill satisfactory accuracy. When weak classifiers are selected, if there are already selected ones, more weight is given to learning with respect to training samples that are erroneously classified by the already selected weak classifiers so that, out of the remaining weak classifiers, the most effective weak classifiers are selected.

As shown in FIG. 4, first, from the input image 30, for example at a reduction factor of 0.8, reduced images 31 to 35 are generated and hierarchized. In each of the images 30 to 35, checking is performed in a checking region 40, whose size is equal in all the images 30 to 35. As indicated by arrows in the figure, on each image, the checking region 40 is moved from left to right to perform scanning in the horizontal direction. The horizontal scanning is performed from top to bottom so that the entire image is scanned. Meanwhile, a face image that matches the checking region 40 is searched for. Here, generating the plurality of reduced images 31 to 35 in addition to the input image 30 makes it possible to detect differently sized faces by use of a single weight table. Scanning may be performed in any order other than specifically described above.

Matching involves a plurality of checking steps proceeding from a coarse checking to increasingly fine checkings. If the face is not detected in one checking step, no advance is made to the next step, and it is judged that the face is not present in the checking region 40. Only when the face is detected in all the checking steps is it judged that the face is present in the checking region 40, in which case the checking region is scanned, and then an advance is made to checking in the next checking region 40. In the practical example described above, a face as seen from in front is detected; instead, the orientation of the main subject's face or the like may be detected by use of samples of face profiles.

Through face detection processing by the above-described or another method, it is possible to detect from the input image a face region including the main subject's face. Then, in this practical example, the main subject detection portion 61 outputs, for example, information on the position of the detected face region in the input image as main subject position information.

With the configuration of this practical example, it is possible to obtain, easily and accurately, a clipped image having a composition centered around the expression on the main subject's face.

The face detection may involve detection of the orientation of the main subject's face so that the main subject position information contains it. To allow detection of the orientation of the main subject's face, for example, samples of face profiles may be used in the above-described example of the detection method. The faces of particular people may be recorded as samples so that face recognition processing is performed to detect those particular people. A plurality of face regions detected may be outputted as the main subject position information.

### Practical Example 2

Main Subject Detection Portion: In Practical Example 2, the main subject detection portion 61 detects the position of the main subject by use of tracking processing. In this practical example also, as the main subject detection information shown in FIG. 2, the input image is used.

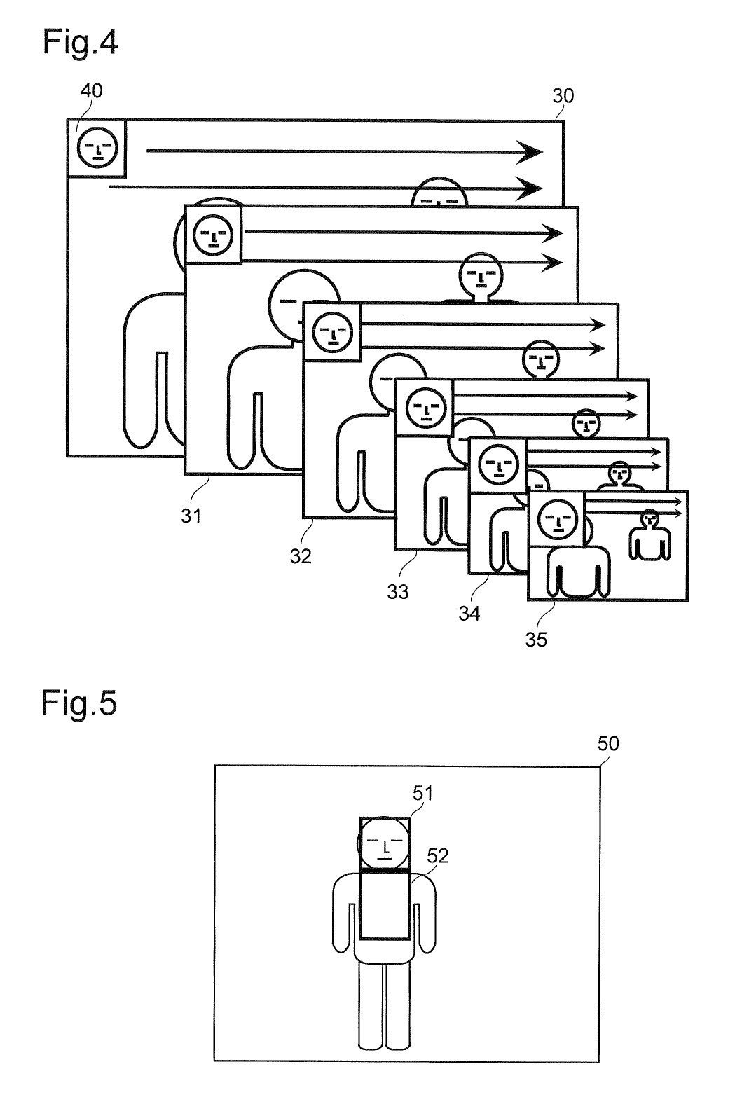

An example of a tracing processing method will now be described with reference to the relevant drawing. FIG. 5 is a schematic diagram illustrating an example of the detection method adopted by the main subject detection portion in Practical Example 2. It illustrates, in particular, an example of a tracking processing method. It should be understood that the method shown in FIG. 5 is merely an example, and any other known tracking processing method may be used instead.

The tracking processing method shown in FIG. 5 uses the result of the face detection processing described in connection with Practical Example 1. As shown in FIG. 5, the tracking processing method of this practical example first performs face detection processing to detect a face region 51 of the main subject from the input image 50. It then sets a body region 52 including the main subject' body below the face region 51 (in the direction pointing from the brow to the mouth), adjacent to the face region 51.

Then, with respect to the input image 50 sequentially fed in, the body region 52 is continuously detected, and thereby the main subject is tracked. The tracking processing here is performed based on the color of the body region 52 (e.g., based on the value of a signal indicating color, such as color difference signals UV, RGB signals, or an H signal among H (hue), S (saturation), and B (brightness) signals). Specifically, for example, when the body region 52 is set, the color of the body region 52 is recognized and stored, and, from the image fed in thereafter, a region having a color similar to the recognized color is detected, thereby to perform tracing processing.

Through tracking processing by the above-described or another method, it is possible to detect a body region 52 of the main subject from the input image. In this practical example, the main subject detection portion 61 then outputs, for example, information on the position of the detected body region 52 in the input image as main subject position information.

With the configuration of this practical example, it is possible to continue to detect the main subject accurately. In particular, it is possible to make it less likely to mistake something else as the main subject in the middle of shooting.

### Practical Example 3

Main Subject Detection Portion: In Practical Example 3, the main subject detection portion 61 detects the position of the main subject by use of encoding information at the time of compression processing by the compression processing portion 8. In this practical example, as the main subject detection information shown in FIG. 2, encoding information is used.

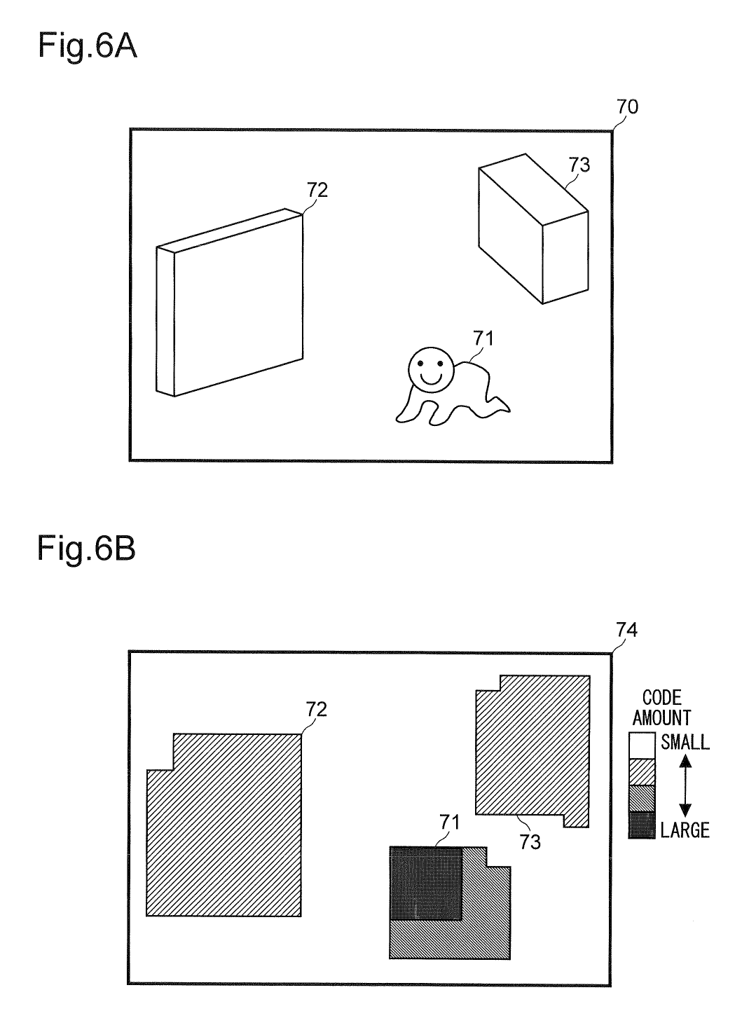

An example of encoding information will now be described with reference to the relevant drawings. FIGS. 6A and 6B are schematic diagrams illustrating an example of the detection method adopted by the main subject detection portion in Practical Example 3. They illustrate, in particular, encoding information. FIG. 6A shows an example of the input image; FIG. 6B shows an example of encoding information obtained when the input image in FIG. 6A is encoded, and schematically shows assignment of code amounts (bit rates).

The compression processing portion 8 uses, for example, a compression processing method according to which, by use of a plurality of input images at different times, a predicted image at a given time is generated and the difference between the input image and the predicted image is encoded. In a case where this type of compression processing method is used, an object in motion is assigned a larger amount of code than other objects. In this practical example, according to how different amounts of code are assigned at the time of compression processing of the input image, the main subject is detected.

In the input image 70 shown in FIG. 6A, an infant 71 is the only object in motion, with other objects 72 and 73 stationary. In this case, in the encoding information 74 obtained by use of the input image 70, only the region of the infant 71 is assigned a larger amount of code. Under the influence of a shake or the like of the image shooting device 1, slightly larger amounts of code may be assigned to the regions of the other objects 72 and 73.

By use of encoding information 74 that accompanies compression processing, it is possible to detect a region 71 with a larger amount of code (a region including the main subject) from the input image 70. In this practical example, the main subject detection portion 61 then outputs, for example, information on the position of the detected region 71 with a larger amount of code in the input image 70 as main subject position information.

As shown in FIG. 6B, amounts of code may be calculated area by area for areas each composed of a plurality of pixels (e.g., 8×8), or may be calculated pixel by pixel. The compression method adopted by the compression processing portion 8 may be a method like MPEG or H.264.

With the configuration of this practical example, it is possible to detect the main subject simply by detecting a region with a larger amount of code. This makes it easy to detect the main subject. Moreover, it is possible to detect, as the main subject, various objects in motion.

### Practical Example 4

Main Subject Detection Portion: In Practical Example 4, the main subject detection portion 61 detects the position of the main subject by use of evaluation values that serve as indicators when control for AF (automatic focus), AE (automatic exposure), and AWB (automatic white balance), respectively, is performed. In this practical example, as the main subject detection information shown in FIG. 2, at least one of an AF evaluation value, an AE evaluation value and an AWB evaluation value is used. These evaluation values are calculated based on the input image.

The AF evaluation value can be calculated, for example, by processing the high-frequency components of the brightness values of the individual pixels in the input image, area by area for areas each composed of a plurality of pixels. An area with a large AF evaluation value is considered to be in focus. Thus, an area with a large AF evaluation value can be estimated to be the area that includes the main subject the user intends to shoot.

The AE evaluation value can be calculated, for example, by processing the brightness values of the individual pixels in the input image, area by area for areas each composed of a plurality of pixels. An area with an AE evaluation value close to a given optimal value is considered to have optimal exposure. Thus, an area with an AE evaluation value close to the optimal value can be estimated to be the area that includes the main subject the user intends to shoot.

The AWB evaluation value can be calculated, for example, by processing component values (e.g., the R, G, and B values, or the values of color difference signals UV) of the individual pixels in the input image, area by area for areas each composed of a plurality of pixels. For another example, the AWB evaluation value may be expressed by the color temperature calculated from the proportion of component values in each such area. An area with an AWB evaluation value close to a given optimal value is considered to have an optimal white balance. Thus, an area with an AWB evaluation value close to the optimal value can be estimated to be the area that includes the main subject the user intends to shoot.

By use of at least one of the above-mentioned evaluation values, it is possible to detect an area including the main subject from the input image. In this practical example, the main subject detection portion 61 then outputs, for example, information on the position of the detected area in the input image as main subject position information.

With the configuration of this practical example, it is possible to detect the main subject by use of evaluation values needed to adjust the input image. This makes it easy to detect the main subject. Moreover, it is possible to detect, as the main subject, various objects.

Any of the evaluation values mentioned above may be calculated area by area for areas each composed of a plurality of pixels, or may be calculated pixel by pixel.

### Practical Example 5

Main Subject Detection Portion: In Practical Example 5, the main subject detection portion 61 detects the position of the main subject by use of a sound signal. In this practical example, as the main subject detection information shown in FIG. 2, the sound signal corresponding to the input image is used. The sound signal corresponding to the input image is, for example, the sound signal generated based on the sounds collected when the input image is shot, and is the sound signal temporarily associated with the input image in the compression processing portion 8 at the succeeding stage.

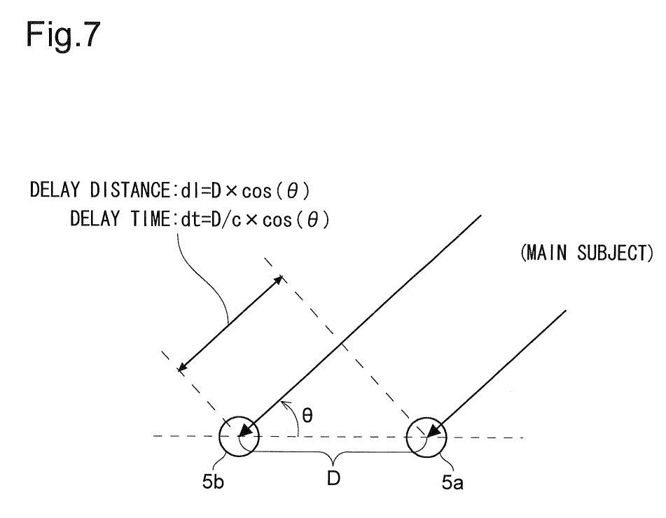

An example of the main subject detection method in this practical example will now be described with reference to the relevant drawing. FIG. 7 is a schematic diagram illustrating an example of the detection method adopted by the main subject detection portion in Practical Example 5. It shows, in particular, an example of a case where the sounds coming from the main subject is collected. In the following description of this practical example, it is assumed that the sound collecting portion 5 shown in FIG. 1 is a microphone array provided with at least two microphones.

As shown in FIG. 7, the sounds emanating from the main subject and reaching microphones 5a and 5b are collected and converted into sound signals by the microphones 5a and 5b respectively. Here, a time difference arises between the sounds reaching the microphones 5a and 5b which is commensurate with the angle of arrival θ formed between the straight line connecting the main subject to the microphones 5a and 5b and the straight line connecting between the microphones 5a and 5b. It is here assumed that the distance D between the microphones 5a and 5b is sufficiently small compared with the distance from the microphones 5a and 5b to the main subject, and that the straight lines connecting the main subject to the microphones 5a and 5b respectively are substantially parallel. It is also assumed that the angle of arrival θ in this practical example is the angle formed between the straight line connecting between the microphones 5a and 5b and the straight line connecting the main subject to the microphones 5a and 5b.

In this case, by calculating the time difference (delay time) between the sounds reaching the microphones 5a and 5b from the main subject, it is possible to calculate the angle of arrival θ. In particular, since dividing the delay distance dl=D×cos(θ) by the speed of sound c (≈344 m/sec) gives the delay time dt, based on the delay time dt it is possible to calculate the angle of arrival θ. The delay time dt can be calculated, for example, by comparing the sound signals obtained from the microphones 5a and 5b respectively on the time axis (e.g., by pattern matching).

It is also possible to compare the sound signals obtained from the microphones 5a and 5b respectively on the frequency axis to calculate, based on the phase difference so determined, the direction of arrival. For example, by processing the sound signals obtained from the microphones 5a and 5b according to formula (1) noted below, the phase difference φ is calculated. In formula (1) below, spec_r(i) represents the component in the frequency band i of the sound signal obtained by the microphone 5a collecting sounds; spec_l(i) represents the component in the frequency band i of the sound signal obtained by the microphone 5b collecting sounds. To calculate the component in the frequency band i of each sound signal, the sound signals may each be subjected to FFT (fast Fourier transform) processing.

$$φ = {tan}^{- 1} ( \frac{spec\_r ( i )}{spec\_ 1 ( r )} ) \qquad ( 1 )$$

In a case where 0°≦θ<90° as shown in FIG. 7, the phase difference φ has a positive value; in a case where 90°≦θ<180°, the phase difference φ has a negative value;

By use of sound signals obtained from a plurality of microphones 5a and 5b, it is possible to detect the direction in which the main subject is present. In this practical example, the main subject detection portion 61 then outputs, for example, in formation on the position of the main subject in the input image as found based on the detected direction in which the main subject is present, as the main subject position information.

With the configuration of this practical example, it is possible to detect the main subject based on a sound signal. Thus, it is possible to detect, as the main subject, various objects that make sounds.

Although the above description deals with a case, as an example, where two sound signals obtained from two microphones 5a and 5b provided in the sound collecting portion 5 are used, the number of sound signals used is not limited to two; three or more sound signals obtained from three or more microphones may instead by used. Using an increased number of sound signals leads to more accurate determination of the direction in which the main subject is present, and is therefore preferable.

### Modified Examples

Main Subject Detection Portion: The main subject position information may be information that indicates a certain region (e.g., a face region) in the input image, or may be information that indicates a certain point (e.g., the center coordinates of a face region).

The main subject detection portions of the different practical examples described above may be used not only singly but also in combination. For example, it is possible to weight and integrate a plurality of detection results obtained by the different methods described above to output the ultimate result as main subject position information. With this configuration, the main subject is detected by different methods, and this makes it possible to detect the main subject more accurately.

The different detection methods may be prioritized so that, when detection is impossible by a detection method with a higher priority, the main subject is detected by use of a detection method with a lower priority and the thus obtained detection result is outputted as main subject position information.

### Clipping Region Setting Portion

Next, the clipping method adopted by the clipping region setting portion 62 will be described in detail by way of a few practical examples, with reference to the relevant drawings. For the sake of concrete description, the following description deals with a case where clipping region information is set and outputted based on the main subject position information (face region) outputted from the main subject detection portion 61 of Practical Example 1

### Practical Example 1

Clipping Region Setting Portion: In Practical Example 1, the clipping region setting portion 62 determines the clipping region based on composition information entered by the user's operation. The composition information is entered, for example, during display of a preview image before starting of recording of an image.

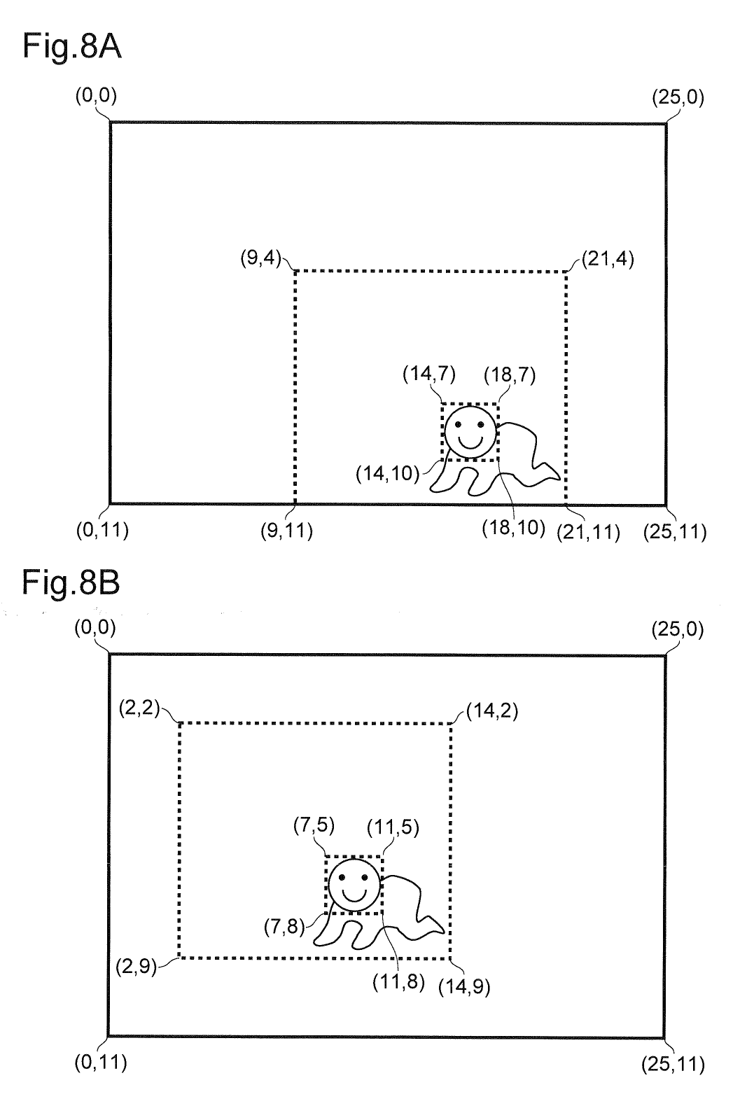

An example of the clipping region setting method adopted by the clipping region setting portion 62 in this practical example will now be described with reference to the relevant drawings. FIGS. 8A and 8B are schematic diagrams illustrating an example of the clipping method adopted by the clipping region setting portion in Practical Example 1. In FIGS. 8A and 8B, it is assumed that the input image has the following coordinates: upper-left, (0, 0); upper-right, (25, 0); lower-left, (0, 11); and lower-right, (25, 11).

In the example shown in FIG. 8A, it is assumed that the face region has the following coordinates: upper-left, (14, 7); upper-right, (18, 7); lower-left, (14, 10); and lower-right, (18, 10); it is also assumed that the clipping region has the following coordinates: upper-left, (9, 4); upper-right, (21, 4); lower-left, (9, 11); and lower-right, (21, 11). In this case, the positional relationship between the clipping region and the face region is, for example if expressed in terms of (Coordinates of Clipping Region)−(Coordinates of Face Region), as follows: upper-left, (−5, −3); upper-right, (3, −3); lower-left, (−5, 1); and lower-right, (3, 1).

On the other hand, in the example shown in FIG. 8B, it is assumed that the face region has the following coordinates: upper-left, (7, 5); upper-right, (11, 5); lower-left, (7, 8); and lower-right, (11, 8); it is also assumed that the clipping region has the following coordinates: upper-left, (2, 2); upper-right, (14, 2); lower-left, (2, 9); and lower-right, (14, 9). In this case, the positional relationship between the clipping region and the face region is, for example if expressed in terms of (Coordinates of Clipping Region)−(Coordinates of Face Region), as in FIG. 8A, as follows: upper-left, (−5, −3); upper-right, (3, −3); lower-left, (−5, 1); and lower-right, (3, 1).

As in the examples shown in FIGS. 8A and 8B, in this practical example, the set positional relationship (composition information) between the position indicated by the main subject position information (e.g., face region) and the position of the clipping region is maintained irrespective of the position of the main subject. The clipping portion 63 then cuts out only the clipping region from the input image, and thereby a clipped image is obtained.

With the configuration described above, it is possible to obtain easily a clipped image with the user's desired composition maintained.

When the user decides the composition, the operation portion 16 provided in the image shooting device 1 may be used. The operation portion 16 may be a touch panel, or may be an arrangement of buttons such as arrow keys.

### Practical Example 2

Clipping Region Setting Portion: In Practical Example 2, as in Practical Example 1, the clipping region setting portion 62 determines the clipping region based on composition information entered by the user's operation. In this practical example, however, the composition information can be changed during shooting.

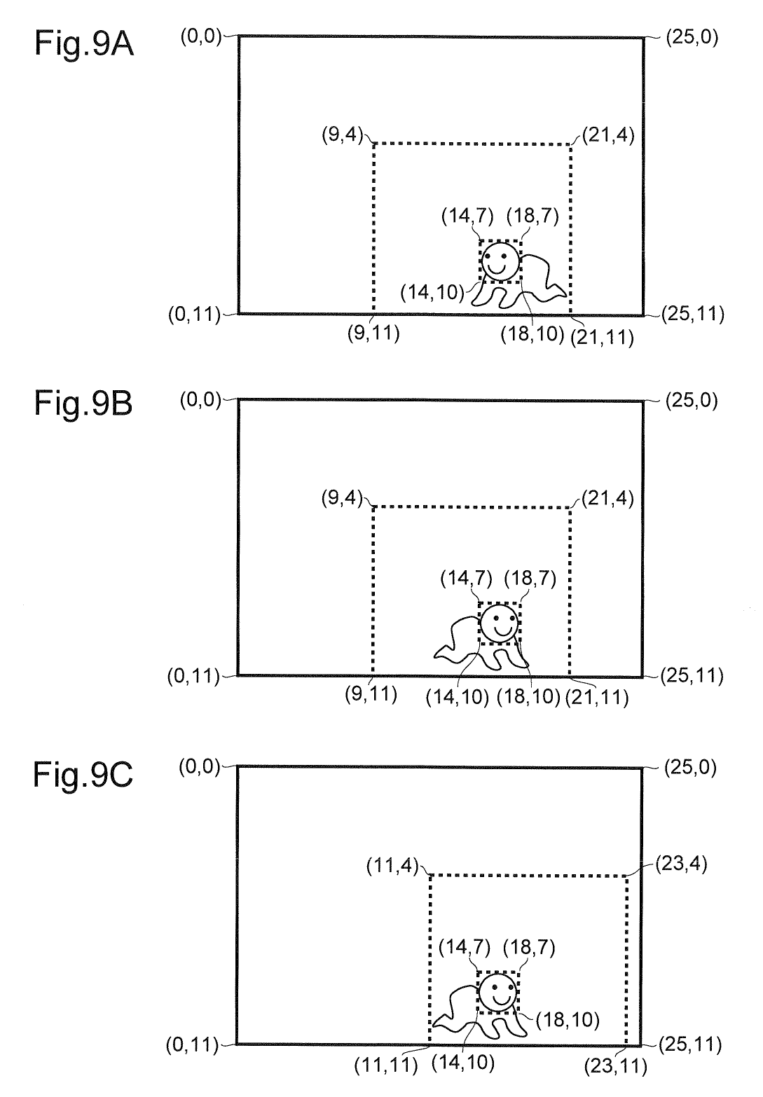

An example of the clipping region setting method adopted by the clipping region setting portion 62 in this practical example will now be described with reference to the relevant drawings. FIGS. 9A to 9C are schematic diagrams illustrating an example of the clipping method adopted by the clipping region setting portion in Practical Example 2, and correspond to FIGS. 8A and 8B described in connection with Practical Example 1. In FIGS. 9A to 9C also, it is assumed that the input image has the following coordinates: upper-left, (0, 0); upper-right, (25, 0); lower-left, (0, 11); and lower-right, (25, 11).

FIG. 9A shows a state similar to that shown in FIG. 8A. Specifically, here, the face region has the following coordinates: upper-left, (14, 7); upper-right, (18, 7); lower-left, (14, 10); and lower-right, (18, 10); the clipping region has the following coordinates: upper-left, (9, 4); upper-right, (21, 4); lower-left, (9, 11); and lower-right, (21, 11). The positional relationship between the clipping region and the face region is, for example if expressed in terms of (Coordinates of Clipping Region)−(Coordinates of Face Region), as follows: upper-left, (−5, −3); upper-right, (3, −3); lower-left, (−5, 1); and lower-right, (3, 1). In addition, in FIG. 9A, it is assumed that the direction of movement of the main subject is leftward.

FIG. 9B shows a case where the direction of movement of the main subject is rightward. The position of the face region, however, is the same as in FIG. 9A. Accordingly, the clipping region has similar coordinates as in the case shown in FIG. 9A. In the case shown in FIG. 9A, the user has decided the composition in view of the fact that the main subject is moving leftward. If, therefore, the main subject changes its direction of movement as shown in FIG. 9B, the user may want to change the composition.

To cope with that, this practical example permits the composition (the positional relationship between the position of the main subject and the clipping region) to be changed during shooting. The composition can be changed, for example, when a situation as shown in FIG. 9B occurs. When the composition is changed, the composition that has been used until then is canceled. At this time, for example, composition information requesting cancellation of the composition may be fed to the clipping region setting portion 62, or composition information different from that which has been used until immediately before the change may be fed to the clipping region setting portion 62.

Thereafter, when the user decides a new composition, composition information indicating the new composition is fed to the clipping region setting portion 62. The clipping region setting portion 62 then determines, as shown in FIG. 9C, a clipping region with the new composition. In the example shown in FIG. 9C, it is assumed that the face region has the following coordinates: upper-left, (14, 7); upper-right, (18, 7); lower-left, (14, 10); and lower-right, (18, 10); it is assumed that the clipping region has the following coordinates: upper-left, (11, 4); upper-right, (23, 4); lower-left, (11, 11); and lower-right, (23, 11). In this case, the positional relationship between the clipping region and the face region is, for example if expressed in terms of (Coordinates of Clipping Region)−(Coordinates of Face Region), as follows: upper-left, (−3, −3); upper-right, (5, −3); lower-left, (−3, 1); and lower-right, (5, 1).

With this configuration, the user can decide a composition as he desires in accordance with the condition of the main subject. Thus, it is possible to make it less likely to continue generating clipped images with an unnatural composition.

The composition information used after the previous composition information is cancelled until new composition information is set may be similar to the composition information before cancellation, or may be composition information previously set for use during cancellation. When the user decides the composition, the operation portion 16 provided in the image shooting device 1 may be used. The operation portion 16 may be a touch panel, or may be an arrangement of buttons such as arrow keys.

### Practical Example 3

Clipping Region Setting Portion: In Practical Example 3, the clipping region setting portion 62 automatically decides the optimal composition based on the main subject position information fed to it. In this respect, Practical Example 3 differs from Practical Examples 1 and 2, where the composition is decided and changed according to user instructions.

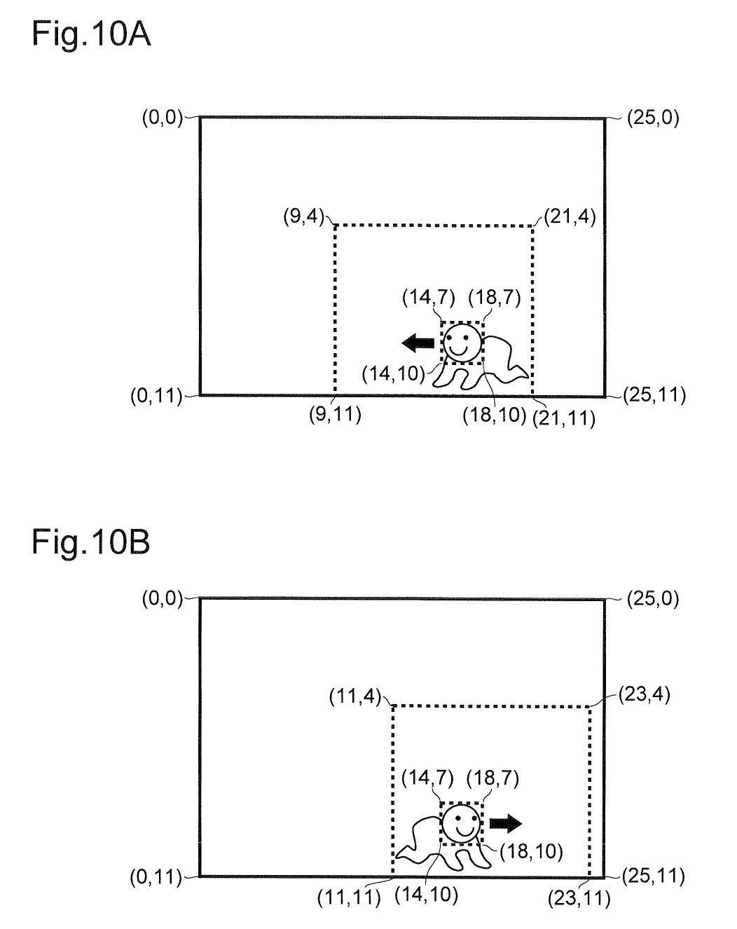

An example of the clipping region setting method adopted by the clipping region setting portion 62 in this practical example will now be described with reference to the relevant drawings. FIGS. 10A and 10B are schematic diagrams illustrating an example of the clipping method adopted by the clipping region setting portion in Practical Example 3, and correspond to FIGS. 8A and 8B described in connection with Practical Example 1. In FIGS. 10A and 10B also, it is assumed that the input image has the following coordinates: upper-left, (0, 0); upper-right, (25, 0); lower-left, (0, 11); and lower-right, (25, 11).

As shown in FIGS. 10A and 10B, in this practical example, it is assumed that the main subject position information includes not only information on the position of the main subject but also information indicating the condition of the main subject (e.g., the orientation of the face). In FIGS. 10A and 10B, the orientation of the face of the main subject is indicated by a solid-black arrow. In the present specification and the appended claims, the “orientation” of an object denotes how it is oriented, as typically identified by the direction its representative face (e.g., in the case of a human, his face) faces or points to.

FIG. 10A shows a state similar to that shown in FIG. 8A. Specifically, here, the face region has the following coordinates: upper-left, (14, 7); upper-right, (18, 7); lower-left, (14, 10); and lower-right, (18, 10); the clipping region has the following coordinates: upper-left, (9, 4); upper-right, (21, 4); lower-left, (9, 11); and lower-right, (21, 11). The positional relationship between the clipping region and the face region is, for example if expressed in terms of (Coordinates of Clipping Region)−(Coordinates of Face Region), as follows: upper-left, (−5, −3); upper-right, (3, −3); lower-left, (−5, 1); and lower-right, (3, 1). In FIG. 10A, however, it is assumed that the orientation of the face of the main subject has been detected to be leftward.

On the other hand, the example shown in FIG. 10B deals with a case where the orientation of the face of the main subject has changed from leftward to right ward. In the case shown in FIG. 10B also, it is assumed that the face region has the following coordinates: upper-left, (14, 7); upper-right, (18, 7); lower-left, (14, 10); and lower-right, (18, 10); it is thus in the same position as in FIG. 10A.

In the case shown in FIG. 10B, it is assumed that the clipping region determined by the clipping region setting portion 62 has the following coordinates: upper-left, (11, 4); upper-right, (23, 4); lower-left, (11, 11); and lower-right, (23, 11). The positional relationship between the clipping region and the face region is, for example if expressed in terms of (Coordinates of Clipping Region)−(Coordinates of Face Region), unlike in FIG. 10A, as follows: upper-left, (−3, −3); upper-right, (5, −3); lower-left, (−3, 1); and lower-right, (5, 1).

FIGS. 10A and 10B each show a case where the clipping region is so set that the face region in the clipping region is located rather in the direction opposite to the orientation of the face. Such setting may be done by the user, or may be previously recorded in the image shooting device.

With the configuration described above, when the main subject changes its state, the composition can be changed easily. In particular, it is possible to save the trouble of the user manually setting a new composition as in Practical Example 2. Moreover, since changing the composition does not take time, it is possible to make it less likely to generate clipped images with an unnatural composition at the time of the change.

Moreover, by deciding the clipping region so that the main subject in the clipping region is located rather in the direction opposite to the orientation of the face, it is possible to include in the clipped image the region to which the main subject is supposed to be paying attention.

Although the above example deals with a case where the orientation of the face is used as information indicating the condition of the main subject, information usable as information indicating the condition of the main subject is not limited to such information; it may instead be, for example, the direction of sight of the main subject, or the motion vector of the main subject. When the direction of sight of the main subject is used, operation similar to that when the orientation of the face is used may be used. A case where the motion vector of the main subject is used will now be described with reference to the relevant drawings.

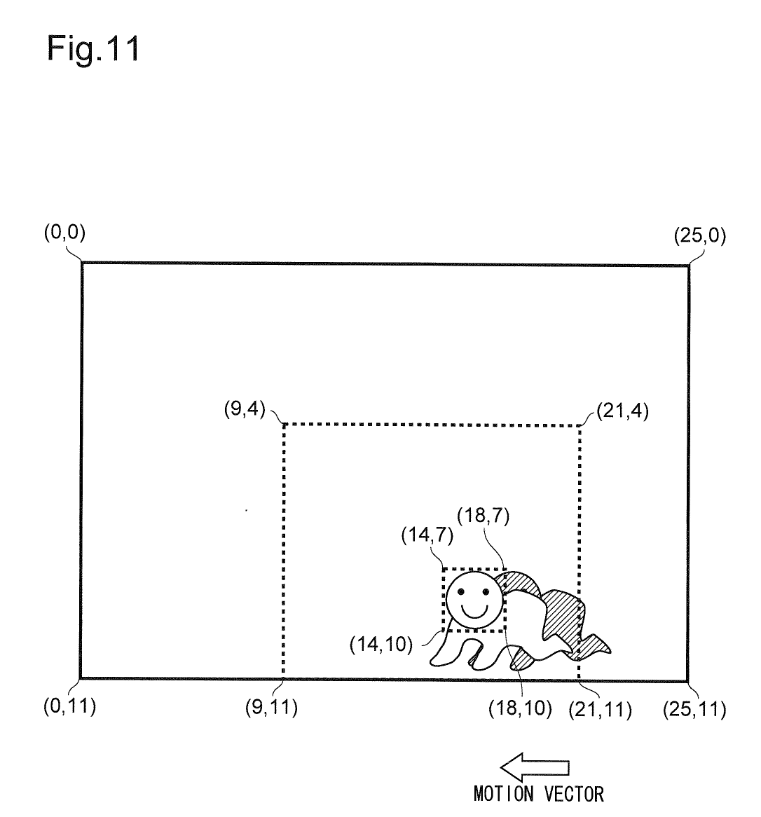

FIG. 11 is a schematic diagram illustrating another example of the clipping method adopted by the clipping region setting portion in Practical Example 3, and corresponds to FIGS. 10A and 10B showing one example of this practical example. In FIG. 11 also, it is assumed that the input image has the following coordinates: upper-left, (0, 0); upper-right, (25, 0); lower-left, (0, 11); and lower-right, (25, 11), and it is assumed that the face region has the following coordinates: upper-left, (14, 7); upper-right, (18, 7); lower-left, (14, 10); and lower-right, (18, 10).

In FIG. 11, the hatched part indicates the main subject in the input image processed previously to the current input image. By comparing the current input image with the previous input image, a motion vector as shown in the figure is calculated. The motion vector may be calculated by any known method.

For example, the motion vector may be calculated by one of various matching methods such as block matching and representative point matching. Instead, the motion vector may be calculated by use of variations in the pixel values of the pixels of and near the main subject. The motion vector may be calculated area by area. It is also possible to adopt a configuration wherein the main subject detection information is a plurality of input images, the main subject detection portion 61 calculates the motion vector, and the main subject position information includes the motion vector (see FIG. 2).

As shown in FIG. 11, in this example, the clipping region is determined so that the main subject (face region) in the clipping region is located rather in the direction opposite to the direction indicated by the motion vector. For example, the clipping region has the following coordinates: upper-left, (9, 4); upper-right, (21, 4); lower-left, (9, 11); and lower-right, (21, 11), and the positional relationship between the clipping region and the face region is, for example if expressed in terms of (Coordinates of Clipping Region)−(Coordinates of Face Region) as follows: upper-left, (−5, −3); upper-right, (3, −3); lower-left, (−5, 1); and lower-right, (3, 1).

With this configuration also, it is possible to change the composition easily and automatically as the main subject changes its state. Moreover, by deciding the clipping region so that the main subject is located rather in the direction opposite to the direction indicated by the motion vector, it is possible to make it clear in what direction and how the main subject is moving.

The composition may be changed with hysteresis such that the composition remains unchanged for a predetermined period. With this configuration, it is possible to make it less likely to generate unnatural clipped images as a result of the composition being changed too frequently in accordance with the condition of the main subject.

### Modified Examples

Clipping Region Setting Portion: In any of the practical examples described above, coordinates may be in the unit of pixels, or in the unit of areas. Composition information may be the differences in coordinates between the position of the clipping region and the position indicated by the main subject position information, or may be the factors by which the region indicated by the main subject position information is enlarged in the up/down and left/right directions respectively.

In a case where the main subject moves to an edge of the input image and the clipping region determined according to composition information goes out of the input image, the composition information may be changed so that the clipping region lies within the input image. Instead, the angle of view of the input image may be made wider as by making the zoom magnification of the image shooting device 1 lower, so that the main subject is located away from an edge of the input image.

When the size of the region of the main subject indicated by the main subject position information is variable, the size of the determined clipping region may increase or decrease in accordance with the size of the region of the main subject. The clipping portion 63 may then enlarge (e.g., by pixel interpolation) or reduce (e.g., by pixel thinning-out or arithmetic averaging) the clipped image to form it into an image of a predetermined size. In that case, composition information may be the factors by which the region indicated by the main subject position information is enlarged in the up/down and left/right directions respectively.

The clipping region setting portions 62 of the different practical examples described above may be used not only singly but also in combination. For example, in the clipping region setting portion 62 of Practical Example 2, after the user cancels the composition until he sets a new composition, it is possible to adopt a composition decided by the clipping region setting portion 62 of Practical Example 3.

Application in Cases where the Main Subject is Composed of a Plurality of Objects

Although the practical examples described above all largely deal with cases in which the main subject is composed of a single object, it is possible to generate a clipped image likewise also in cases where the main subject is composed of a plurality of objects (hereinafter referred to as component subjects). Described specifically below will be the configuration and operation of a clipping processing portion that can generate a clipped image even in cases where the main subject is composed of a plurality of component subjects.

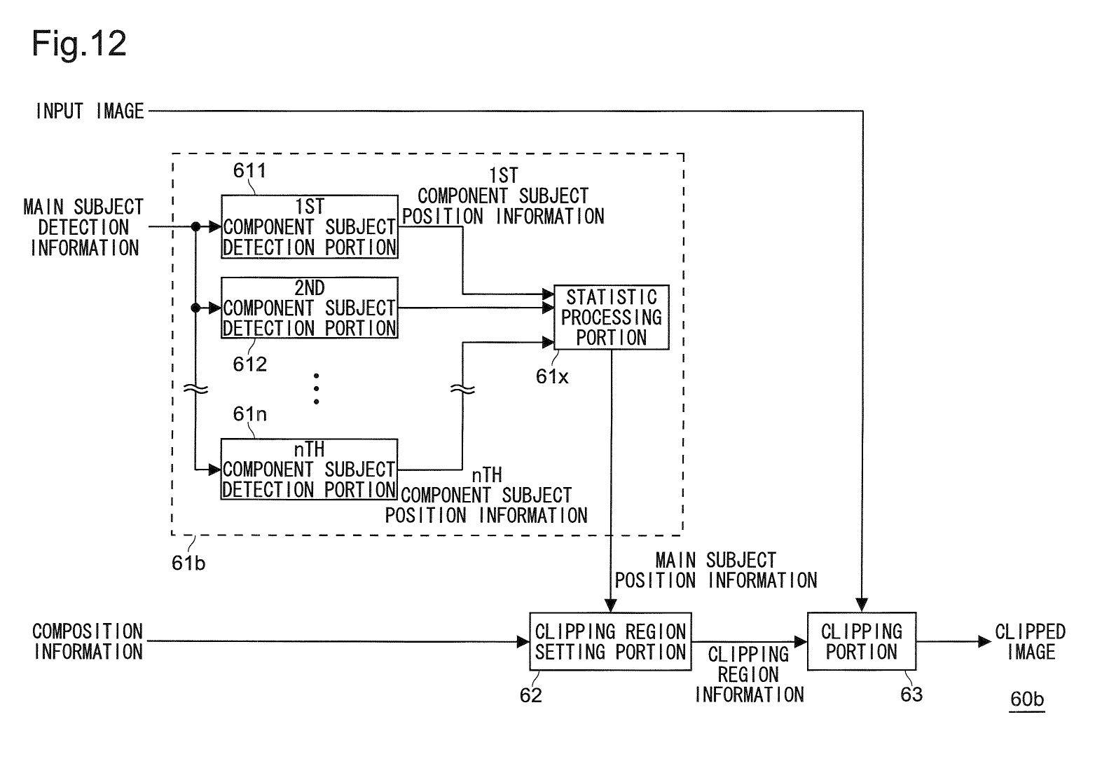

First, an example of the configuration of such a clipping processing portion will be described with reference to the relevant drawings. FIG. 12 is a block diagram showing an example of the configuration of a clipping processing portion that can generate a clipped image even when the main subject is composed of a plurality of component subjects, and corresponds to FIG. 2 showing the basic configuration. Such parts as find their counterparts in FIG. 2 are identified by common reference signs and no detailed description of them will be repeated.

As shown in FIG. 12, the clipping processing portion 60b is provided with a main subject detection portion 61b, a clipping region setting portion 62, and a clipping portion 63. The main subject detection portion 61b here is provided with: a first to an nth component subject detection portion 611 to 61n that, based on main subject detection information, each detect the position of one component subject in the input image to output first to nth component subject position information respectively; and a statistic processing portion 61x that performs statistic processing on the first to nth component subject position information to output main subject position information. Here, n represents an integer of 2 or more.

The first to nth component subject detection portions 611 to 61n perform detection operation similar to that by the main subject detection portion 61 in FIG. 2 described previously, each detecting the position of a different component subject; they then output their respective detection results as the first to nth component subject position information. The first to nth component subject detection portions 611 to 61n may each detect information on a direction such as the face orientation, sight direction, or motion vector of the component subject as described previously. For conceptual representation, FIG. 12 shows the first to nth component subject detection portions 611 to 61n separately; these, however, may be realized as a single block (program) that can detect a plurality of component subjects simultaneously.

The statistic processing portion 61x statistically processes the first to nth component subject position information outputted respectively from the first to nth component subject detection portions 611 to 61n to calculate and output main subject position information indicating the position in the input image of the whole of the component subjects (i.e., the main subject) detected from the input image. In a case where the first to nth component subject position information includes information on a direction such as the face orientation, sight direction, or motion vector of the component subject as described above, such information may also be subjected to statistic processing so that the so obtained information on the direction of the main subject is included in the main subject position information.

Accordingly, the main subject position information may include information on the position of the main subject in the input image (e.g., the position of a rectangular region including all the detected component subjects, or the average position of the component subjects). It may also include information on the face orientation or sight direction of the main subject (e.g., the average face orientation or sight direction of the component subjects) or the direction and magnitude of the motion vector of the main subject (e.g., the average direction and magnitude of the motion vectors of the component subjects).

Like the clipping region setting portion 62 shown in FIG. 2 described previously, the clipping region setting portion 62 here determines a clipping region based on the main subject position information, and outputs clipping region information. The clipping portion 63 then cuts out the clipping region indicated by the clipping region information from the input image to generate a clipped image.

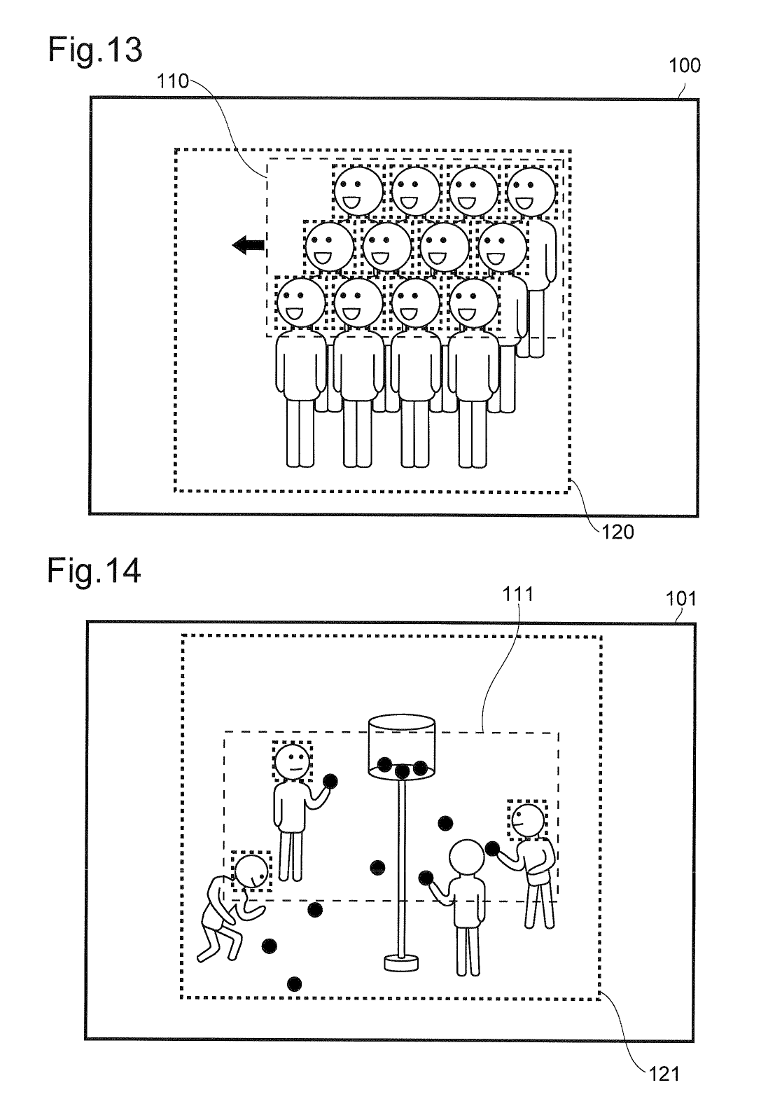

Next, concrete examples of the clipping region setting method adopted by the clipping region setting portion 62 will be described with reference to the relevant drawings. FIGS. 13 to 15 are schematic diagrams showing examples of clipping regions determined based on a plurality of main subjects.

### Concrete Example 1

FIG. 13 shows a case where the face orientations or sight directions of a plurality of component subjects are substantially the same (e.g., people singing in a chorus). The figure shows an input image 100, a main subject position 110 indicated by main subject position information, and a clipping region 120.

The first to nth component subject detection portions 611 to 61n detect component subjects by performing face detection on the input image, which is the main subject detection information. Based on the detection results, i.e., the first to nth component subject position information, the statistic processing portion 61x calculates the main subject position 110. The clipping region setting portion 62 then determines the clipping region 120 based on the main subject position 110 and the face orientation of the main subject.

In this concrete example, the face orientation or sight direction of the main subject is calculated as a particular direction (indicated by a solid-black arrow in the figure, specifically leftward). Accordingly, the clipping region setting portion 62 determines the clipping region 120 so that the main subject position 110 is rather in the direction (leftward in the figure) opposite to the face orientation or sight direction (rightward in the figure) of the main subject. Here, the clipping region 120 may be so determined as to include all the component subjects.

With this configuration, it is possible to determine, easily and automatically, a clipping region 120 that has a composition according to the condition of the main subject (the plurality of component subjects). In particular, it is possible to determine a clipping region 120 in which the region to which the component subjects are supposed to be paying attention is clear.

In this concrete example, the first to nth component subject detection portions 611 to 61n may detect their respective main subjects by use of a detection method similar to that used by the main subject detection portion 61 of Practical Example 1 described previously. The clipping region setting portion 62 may determine the clipping region by use of a setting method similar to that used by the clipping region setting portion 62 of Practical Example 3 described above (see FIGS. 10A and 10B).

### Concrete Example 2

This concrete example deals with an example of the clipping region setting method for cases where, in Concrete Example 1, the face orientation or sight direction varies among the individual component subjects (with a correlation equal to or less than a predetermined level) and it is thus difficult to calculate the face orientation or sight direction of the main subject as a particular direction (the calculated direction has low reliability). FIG. 14 shows a case in which the face orientation or sight direction varies among the component subjects (e.g., people playing a field event tamaire (“put-most-balls-in-your-team's-basket”)). The figure shows an input image 101, a main subject position 111 indicated by main subject position information, and a clipping region 121.

In this concrete example, it is difficult to calculate the face orientation or sight direction of the main subject as a particular direction. Accordingly, the clipping region setting portion 62 determines the clipping region 121 so that it includes the individual component subjects. Here, the clipping region 121 may be so determined that the main subject position 111 is located substantially at the center.

With this configuration, as in Concrete Example 1, it is possible to determine, easily and automatically, a clipping region 120 that has a composition according to the condition of the main subject (the plurality of component subjects). In particular, it is possible to determine a clipping region 121 in which the component subjects with varying face orientations or sight directions can easily be identified individually.

### Concrete Example 3

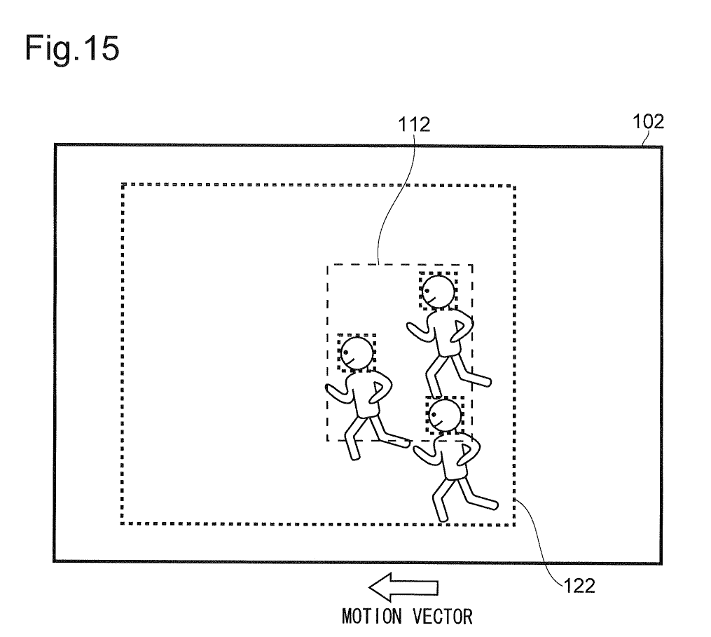

FIG. 15 shows a case where a plurality of component subjects move in the same direction (e.g., people running in a race). The figure shows an input image 102, a main subject position 112 indicated by main subject position information, and a clipping region 122.

The first to nth component subject detection portions 611 to 61n perform face detection on the input image, which is the main subject detection information, to detect the main subject, and in addition calculate the motion vectors of the individual component subjects. Based on the detection results, i.e., the first to nth component subject position information, the statistic processing portion 61x calculates the main subject position 112, and in addition calculates the motion vector of the main subject. The clipping region setting portion 62 then determines the clipping region 122 based on the main subject position 112 and the motion vector of the main subject.

In this concrete example, the motion vector of the main subject is calculated as a particular direction (indicated by a solid-black arrow in the figure, specifically leftward). Accordingly, the clipping region setting portion 62 determines the clipping region 122 so that the main subject position 112 is rather in the direction (leftward in the figure) opposite to the motion vector (rightward in the figure) of the main subject. Here, the clipping region 122 may be so determined as to include all the component subjects.

With this configuration, as in Concrete Examples 1 and 2, it is possible to determine, easily and automatically, a clipping region 122 that has a composition according to the condition of the main subject (the plurality of component subjects). In particular, it is possible to make it clear in which direction and how the component subjects are moving.

In this concrete example, the first to nth component subject detection portions 611 to 61n may detect their respective main subjects by use of a detection method similar to that used by the main subject detection portion 61 of Practical Example 1 described previously, and may calculate motion vectors by use of any one of various known methods (e.g., block matching and representative point matching). The clipping region setting portion 62 may determine the clipping region by use of a setting method similar to that used by the clipping region setting portion 62 of Practical Example 3 described above (see FIG. 11).

As in Concrete Example 2 in comparison with Concrete Example 1, in a case where the motion vector varies among the individual component subjects (with a correlation equal to or less than a predetermined level), the clipping region setting portion 62 may determine the clipping region so that it includes the individual component subjects.

Although Concrete Examples 1 to 3 all deal with a case in which the clipping region is determined based on the position and orientation of the detected main subject (see Practical Example 3 of the clipping region described previously), it is also possible to determine the clipping region based on composition information entered by the user's operation and the position of the main subject (see Practical Examples 1 and 2 of the clipping region described previously).

The plurality of subjects included in the input image may all be taken as component subjects, or those of them selected by the user may be taken as component subjects. Instead, those subjects automatically selected based on correlation among their image characteristics or movement may be taken as component subjects.

### Application to Other Electronic Appliances

The examples described thus far all deal with a case where clipping processing is performed on an input image obtained by the image shooting portion of the image shooting device 1 and the clipped image is recorded (i.e., a case where clipping processing is performed at the time of shooting). The invention, however, can also be applied in a case where clipping processing is performed when an input image recorded in the external memory 10 or the like is read out (i.e., a case where clipping processing is performed at the time of playback).

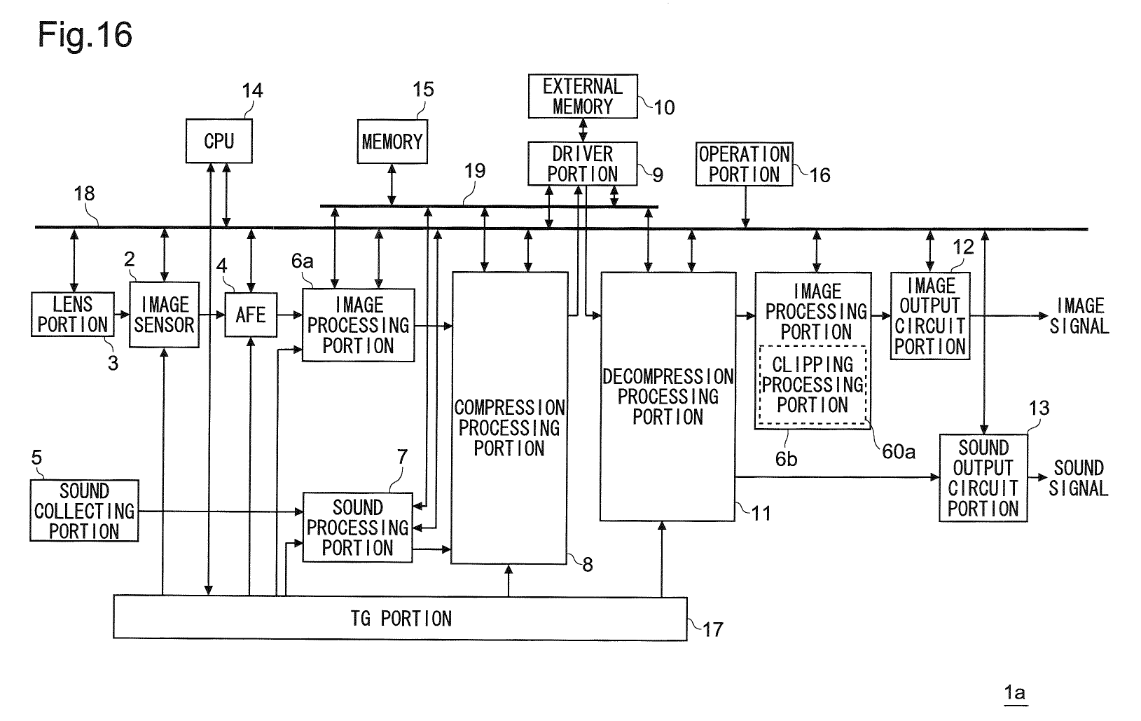

FIG. 16 shows an image shooting device 1a that can perform clipping processing at the time of playback. FIG. 16 is a block diagram showing the configuration of an image shooting device as another embodiment of the invention, and corresponds to FIG. 1. Such parts as find their counterparts in FIG. 1 are identified by common reference signs and no detailed description of them will be repeated.

Compared with the image shooting device 1 of FIG. 1, the image shooting device 1a shown in FIG. 16 is configured similarly, except that it is provided with an image processing portion 6a instead of the image processing portion 6 and that it is additionally provided with an image processing portion 6b that processes the image signal fed to it from the decompression processing portion 11 and outputs the result to the image output circuit portion 12.

Compared with the image processing portion 6 shown in FIG. 1, the image processing portion 6a is configured similarly, except that it is not provided with a clipping processing portion 60. Instead, a clipping processing portion 60a is provided in the image processing portion 6b. The clipping processing portion 60a may be configured similarly to the clipping processing portions 60 and 60b shown in FIGS. 2 and 12. As the main subject detection portion 61 provided in the clipping processing portion 60a, for example, the main subject detection portion 61 of any of Practical Examples 1 to 5 described previously may be used. As the clipping region setting portion 62, for example, the clipping region setting portion 62 of Practical Examples 1 to 3 described previously may be used.

It is assumed that the clipping processing portion 60a provided in the image processing portion 6b can acquire, whenever necessary, various kinds of information (e.g., a sound signal, and encoding information at the time of compression processing) from different parts (e.g., the decompression processing portion 11, etc.) of the image shooting device 1. In FIG. 16, however, illustration is omitted of arrows indicating such information being fed to the clipping processing portion 60a.

In the image shooting device 1a shown in FIG. 16, a compressed/encoded signal recorded in the external memory 10 is read out by the decompression processing portion 11, which then decodes it to output an image signal. This image signal is fed to the image processing portion 6b and to the clipping processing portion 60a so as to be subjected to various kinds of image processing and clipping processing. The configuration and operation of the clipping processing portion 60a are similar to those of the clipping processing portion 60 shown in FIG. 2. The image signal having undergone image processing and clipping processing is fed to the image output circuit portion 12, and is also converted into a format reproducible on a display and a speaker for output.

In a case where, as in this example, clipping processing is performed at the time of playback, since the input image is a recorded one, acquisition of the input image can be stopped. This makes it possible to determine a clipping region in the input image in a still state. Thus, in a case where the user determines the clipping region as in Practical Examples 1 and 2 of the clipping region setting portion 62, it is possible to select and determine a desired clipping region accurately.

The image shooting device 1a allows omission of the image sensor 2, the lens portion 3, the AFE 4, the sound collecting portion 5, the image processing portion 6, the sound processing portion 7, and the compression processing portion 8. That is, it may be configured as a playback-only device provided solely with playback capabilities. It may also be configured so that the image signal outputted from the image processing portion 6b can be recorded to the external memory 10 again. That is, it may be so configured that it can perform clipping processing at the time of editing.

The clipping processing described above can be used, for example, at the time of shooting or playback of a moving image or at the time of shooting of a still image. Cases where it is used at the time of shooting of a still image include, for example, those where one still image is created based on a plurality of images.

### Other Modifications

In the image shooting device 1 or 1a embodying the invention, the operation of the image processing portion 6, 6a, or 6b, the clipping processing portion 60, 60a, or 60b, etc. may be performed by a control device such as a microcomputer. All or part of the functions realized with such a control device may be prepared in the form of a program so that, when the program is executed on a program execution device (e.g., a computer), all or part of those functions are realized.

Without any limitation to such cases as mentioned above, the image shooting device 1 in FIG. 1, the clipping processing portion 60 in FIG. 2, the clipping processing portion 60b in FIG. 12, and the image shooting device 1a and the clipping processing portion 60a in FIG. 16 can be realized in hardware, or in a combination of hardware and software. In a case where the image shooting device 1 or 1a or the clipping processing portion 60, 60a, or 60b is built with software, any block diagram showing the parts realized in software serves as a functional block diagram of those parts.

It should be noted that the embodiments by way of which the invention has been described above are not meant to limit the scope of the invention and allow many variations and modifications without departing from the spirit of the invention.

The present invention relates to an image processing device that cuts out part of an input image to yield a desired clipped image, and to an electronic appliance such as an image shooting device as exemplified by digital video cameras.

What is claimed is:

1. An image processing device comprising:
a main subject detector detecting a position of a main subject in an input image;
a clipping region setter determining a clipping region including the position of the main subject detected by the main subject detector; and
a clipper generating a clipped image by cutting out the clipping region from the input image,
wherein the clipping region setter determines the clipping region such that the position of the main subject detected by the main subject detector coincides with a predetermined position in the clipping region.

2. The image processing device according to claim 1, wherein
the clipping region setter is fed with composition information specifying a relationship between the position of the main subject detected by the main subject detector and a position of the clipping region, and

3. The image processing device according to claim 1, wherein
the main subject detector detects an orientation of the main subject, and
the clipping region setter determines the clipping region based on the orientation of the main subject detected by the main subject detector.

4. The image processing device according to claim 1,
wherein the main subject detector detects the position of the main subject by detecting a face of the main subject from the input image.

5. The image processing device according to claim 1,
wherein the main subject detector detects the position of the main subject from an sound signal corresponding to the input image.

6. The image processing device according to claim 1, wherein
when the main subject is composed of a plurality of component subjects,
the main subject detector detects positions of the individual component subjects in the input image and detects the position of the main subject based on those positions.

7. The image processing device according to claim 6, wherein
the main subject detector detects orientations of the individual component subjects and detects an orientation of the main subject based on those orientations, and
the clipping region setter determines the clipping region based on the orientation of the main subject detected by the main subject detector.

8. The image processing device according to claim 6, wherein
the main subject detector detects orientations of the individual component subjects and detects an orientation of the main subject based on those orientations, and
when a correlation among the orientations of the individual component subjects is equal to or less than a predetermined magnitude,
the clipping region setter determines the clipping region such that the clipping region includes all the component subjects.

9. An electronic appliance comprising the image processing device according to claim 1, wherein the clipped image outputted from the image processing device is recorded or played back.
